(19) United States
(12) Patent Application Publication
(10) Pub. No.: US 2019/0373165 A1
(43) Pub. Date: Dec. 5, 2019

(54) LEARNING TO SWITCH, TUNE, AND RETRAIN AI MODELS

(71) Applicant: WIZR LLC, Santa Monica, CA (US)

(72) Inventors: Genquan DUAN, Los Angeles, CA (US); David CARTER, Marina del Rey, CA (US); Michael MARSHALL, Stevenson Ranch, CA (US); Daniel MAZZELLA, Los Angeles, CA (US); Andrew PIERNO, Santa Monica, CA (US)

(73) Assignee: WIZR LLC, Santa Monica, CA (US)

(21) Appl. No.: 16/408,242

(22) Filed: May 9, 2019

Related U.S. Application Data
(60) Provisional application No. 62/668,929, filed on May 9, 2018.

(51) Int. Cl. H04N 5/232

(52) U.S. Cl. CPC H04N 5/23222; H04N 5/23218; H04N 5/23245

(57) ABSTRACT

Artificial intelligence (AI) models are switched, tuned and retrained. This process may be performed with respect to systems having artificial intelligence engines in connection with video cameras and associated video data streams. An AI model is obtained for a video camera based on, for example, historic video streams from the camera for the past day, week, month, year, or any other time period. The AI model is then modified for the camera after the system obtains, for example, data internal to the video camera, data external to the video camera and data related to objects of interest for the video camera. As the AI model is modified, a processor associated with the system may adopt linear regression algorithms to regress conditions to the modified model and other available models.

### BRIEF DESCRIPTION OF THE FIGURES

These and other features, aspects, and advantages of the present disclosure are better understood when the following Detailed Description is read with reference to the accompanying drawings.

FIG. 1 illustrates a block diagram of a system 100 for multi model switching to tune AI models for a video feed.

FIG. 2 is a flowchart of an example process for multi model switching to tune AI models for a video feed.

FIG. 3 shows an illustrative computational system for performing functionality to facilitate implementation of embodiments described herein.

### DETAILED DESCRIPTION

Systems and methods are disclosed for multi model switching to tune AI models for a video feed.

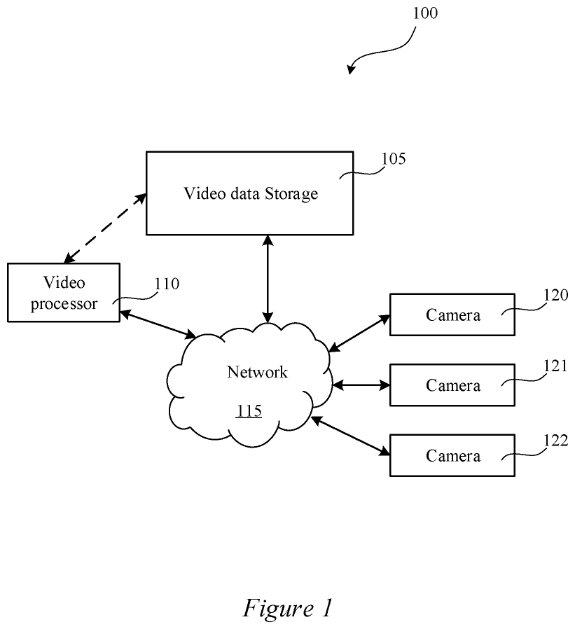

FIG. 1 illustrates a block diagram of a system 100 that may be used in various embodiments. The system 100 may include a plurality of cameras: camera 120, camera 121, and camera 122. While three cameras 120, 121, and 122 are shown, any number of cameras may be included. These cameras 120, 121, and 122 may include any type of video camera such as, for example, a wireless video camera, a black and white video camera, surveillance video camera, portable cameras, battery powered cameras, CCTV cameras, Wi-Fi enabled cameras, smartphones, smart devices, tablets, computers, GoPro cameras, wearable cameras, satellite cameras, etc. The cameras may be positioned anywhere such as, for example, within the same geographic location, in separate geographic locations, positioned to record portions of the same scene, positioned to record different portions of the same scene, etc. In some embodiments, the cameras may be associated with robots. In some embodiments, the robots may include artificial intelligence to perform tasks. In these and other embodiments, the cameras associated with the robots may switch or tune AI models for video feeds based on what is happening in an area around the robots. In some embodiments, the cameras may be owned and/or operated by different users, organizations, companies, entities, etc.

The cameras 120, 121, and 122 may be coupled with the network 115. The network 115 may, for example, include the Internet, a telephonic network, a wireless telephone network, a 3G network, etc. In some embodiments, the network may include multiple networks, connections, servers, switches, routers, connections, etc. that may enable the transfer of data. In some embodiments, the network 115 may be or may include the Internet. In some embodiments, the network may include one or more LAN, WAN, WLAN, MAN, SAN, PAN, EPN, and/or VPN.

In some embodiments, one more of the cameras 120, 121, and 122 may be coupled with a base station, digital video recorder, or a controller that is then coupled with the network 115.

The system 100 may also include video data storage 105 and/or a video processor 110. In some embodiments, the video data storage 105 and the video processor 110 may be coupled together via a dedicated communication channel that is separate from or part of the network 115. In some embodiments, the video data storage 105 and the video processor 110 may share data via the network 115. In some embodiments, the video data storage 105 and the video processor 110 may be part of the same system or systems.

In some embodiments, the video data storage 105 may include one or more remote or local data storage locations such as, for example, a cloud storage location, a remote storage location, etc.

In some embodiments, the video data storage 105 may store video files recorded by one or more of camera 120, camera 121, and camera 122. In some embodiments, the video files may be stored in any video format such as, for example, mpeg, avi, etc. In some embodiments, video files from the cameras may be transferred to the video data storage 105 using any data transfer protocol such as, for example, HTTP live streaming (HLS), real time streaming protocol (RTSP), Real Time Messaging Protocol (RTMP), HTTP Dynamic Streaming (HDS), Smooth Streaming, Dynamic Streaming over HTTP, HTML5, Shoutcast, etc.

In some embodiments, the video data storage 105 may store user identified event data reported by one or more individuals. The user identified event data may be used, for example, to train the video processor 110 to capture feature events.

In some embodiments, a video file may be recorded and stored in memory located at a user location prior to being transmitted to the video data storage 105. In some embodiments, a video file may be recorded by the camera and streamed directly to the video data storage 105. Alternatively or additionally, in some embodiments, a video file may be recorded by the camera and streamed or saved on any number of intermediary servers and/or networks prior to being transmitted to and/or stored on the video data storage 105. For example, in some embodiments, a streaming server, such as a Hypertext Transfer Protocol Live Streaming (HLS) server may stream video data to a video decoding server. The video data may be transmitted from the video decoding server to the video data storage 105.

In some embodiments, the video processor 110 may include one or more local and/or remote servers that may be used to perform data processing on videos stored in the video data storage 105. In some embodiments, the video processor 110 may execute one more algorithms on one or more video files stored with the video storage location. In some embodiments, the video processor 110 may execute a plurality of algorithms in parallel on a plurality of video files stored within the video data storage 105. In some embodiments, the video processor 110 may include a plurality of processors (or servers) that each execute one or more algorithms on one or more video files stored in video data storage 105. Alternatively or additionally, in some embodiments, the video processor 110 may execute one or more algorithms on one or more images from the one or more video files stored in video data storage 105. In some embodiments, the video processor 110 may include one or more of the components of computational system 400 shown in FIG. 4.

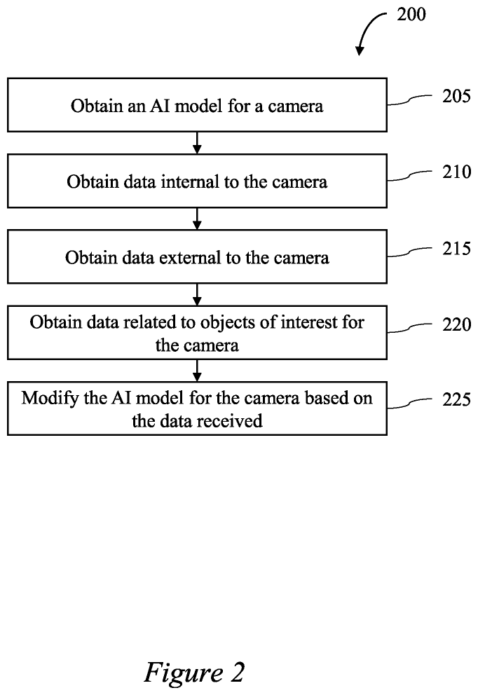

FIG. 2 is a flowchart of an example process 200 for multi model switching to tune AI models. One or more steps of the process 200 may be implemented, in some embodiments, by one or more components of system 100 of FIG. 1, such as video processor 110. Although illustrated as discrete blocks, various blocks may be divided into additional blocks, combined into fewer blocks, or eliminated, depending on the desired implementation.

Process 200 may begin at block 205. At block 205 the system 100 may obtain an AI model for a camera such as, for example, camera 120, camera 121, and/or camera 122. The AI model for the camera may be based on, for example, historic video streams from the camera for the past day, week, month, year, or any other time period. Alternatively or additionally, the AI model for the camera may be based on past external data or factors that may no longer be applicable.

In some embodiments, the AI model may be based on the particular scenes, views, occlusions, weathers, and illumination for the camera. For example, in some embodiments, a model may be associated with a scene for the camera 120. The scene for the camera 120 may be determined using a scene classification model to predict scene labels such as indoor and outdoor. In some embodiments, a model may be associated with a view for the camera 120. The view for the camera 120 may be determined using a view estimation model to predict viewpoint angles. The weather associated with the camera 120 may be determined by examining the video feed from the camera 120 and/or by gathering weather information from an outside source such as the Internet. In some embodiments, one model may be associated with an occlusion possibility for the camera 120. The occlusion possibility may be estimated based on a scene parsing model. In some embodiments, one model may be associated with an illumination for the camera 120. For example, image analysis and time information (potentially from an outside source) may be combined to predict the illumination for the camera 120 during day and/or night. In these and other embodiments, data may be gathered from sensors which may be communicatively coupled with the cameras via a Universal Serial Bus connection, a serial connection, a wireless connection such as a Bluetooth connection or a Wi-Fi connection, or any other data connection.

In some embodiments, the AI model may be based on a strategy for the camera 120. For example, in some embodiments, a user may desire to detect and track a moving blob. In some embodiments, a user may desire to detect and track a pedestrian and/or a head and shoulder combination. In some embodiments, a user may desire to detect and track a car. In some embodiments, a user may desire to detect and track an animal. The AI models for each strategy may have different views and/or different sensitivities.

In some embodiments, at block 210 the video processor 110 may obtain data internal to the camera 120. For example, the video processor 110 may obtain data related to the camera model of the camera 120, the firmware of the camera 120, the status of any systems and/or elements in the camera 120, and/or other data related to the functioning of the camera that is inherent in the camera 120.

In some embodiments, the video processor 110 may modify the AI model for the camera 120. In these and other embodiments, the video processor 110 may learn prediction models related to the models. In these and other embodiments, the video processor 110 may adopt linear regression algorithms to regress conditions to algorithm models. In some embodiments, the video processor 110 may adopt a convolutional neural network (CNN) to regress algorithm models with images as inputs.

In some embodiments, the video processor 110 may apply the prediction models that it has learned. In these and other embodiments, the video processor 110 may obtain snapshots and conditions periodically. For example, in some embodiments, it may obtain snapshots and conditions every hour. The video processor 110 may predict the algorithm model using linear regression. The video processor 110 may predict the algorithm model using CNN. When the predicted models are different than previously applied models, the video processor 110 may switch to a new model.

In some embodiments, the video processor 110 may update models. In some embodiments, there may be general models that may be applied to a variety of different cameras 120, 121, and 122 and specific models that may be applied to a specific camera 120. For example, data from many cameras 120, 121, and 122 may be gathered to generate a general model for a camera 120. In some embodiments, the video processor 110 may collect and label new data from cameras 120, 121, and 122 as new cameras are brought online. In some embodiments, the video processor 110 may retrain the general models. Each model may have a model structure and model parameters. During retraining of the general model, the video processor 110 may keep the model structure but update model parameters. Alternatively or additionally, the video processor 110 may update the model structure by removing one or more layers and/or adding one or more layers. In these and other embodiments, the video processor 110 may learn parameters for the newly added and/or removed layers.

Additionally or alternatively, data from a specific camera 120 may be used to generate a specific model for that camera 120. Data may be collected related to each specific camera 120, 121, and 122. The video processor 110 may learn one model for each specific camera 120, 121, 122. In these and other embodiments, the specific model for a specific camera 120 may be based on one or more general models. In some embodiments, the video processor 110 may keep the model structure of the general model. In some embodiments, the model for a specific camera 120 may be initialized with parameters from the general models based on data for multiple cameras 120, 121, and 122. In these and other embodiments, the parameters for the specific model may be updated based on data from the specific camera 120.

At block 215, the video processor 110 may obtain data external to the camera 120. For example, the video processor 110 may obtain data related to the time of day at the location of the camera 120, the current weather at the location of the camera 120, and other data related to video streams from the camera 120 that are external to the camera 120. For example, in some embodiments the external data may include weather data related to the amount of rainfall occurring at the location where the camera 120 is located. In some embodiments, the external data may include the current level of light at the location where the camera 120 is located.

In some embodiments, the video processor 110 may obtain data related to objects of interest for the camera 120 at block 220. For example, if the camera 120 is being used to determine if any object enters or falls into a pool, any object may be the object of interest. As an another example, if the camera 120 is being used to determine if a person is lingering in front of a window, a person may be the object of interest.

At block 225 the video processor 110 may modify the AI model for the camera 120 based on the data obtained. For example, in some embodiments, the AI model for the camera 120 may be modified based on an update for the firmware for the camera 120. As another example, in some embodiments, the AI model for the camera 120 may be updated as the ambient light level in the area where the camera 120 is located decreases or increases. For example, as the ambient light level decreases, the AI model may be modified to be less sensitive. As the ambient light level increases, the AI model may be modified to be more sensitive. As another example, in some embodiments the AI model for the camera 120 may be updated based on the weather in the area surrounding the camera 120. For example, if it is raining in the area where the camera 120 is located, the AI model may be modified to be less sensitive. In some embodiments, the AI model for the camera 120 may be updated based on past historical data for video streams from the particular camera 120.

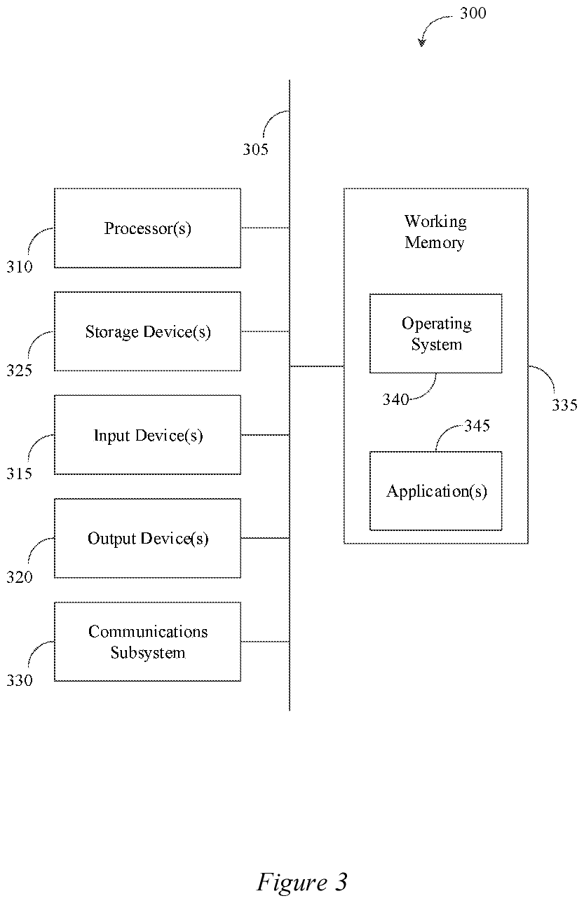

The computational system 300 (or processing unit) illustrated in FIG. 3 can be used to perform and/or control operation of any of the embodiments described herein. For example, the computational system 300 can be used alone or in conjunction with other components. As another example, the computational system 300 can be used to perform any calculation, solve any equation, perform any identification, and/or make any determination described here.

The computational system 300 may include any or all of the hardware elements shown in the figure and described herein. The computational system 300 may include hardware elements that can be electrically coupled via a bus 305 (or may otherwise be in communication, as appropriate). The hardware elements can include one or more processors 310, including, without limitation, one or more general-purpose processors and/or one or more special-purpose processors (such as digital signal processing chips, graphics acceleration chips, and/or the like); one or more input devices 315, which can include, without limitation, a mouse, a keyboard, and/or the like; and one or more output devices 320, which can include, without limitation, a display device, a printer, and/or the like.

The computational system 300 may further include (and/or be in communication with) one or more storage devices 325, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 300 might also include a communications subsystem 330, which can include, without limitation, a modem, a network card (wireless or wired), an infrared communication device, a wireless communication device, and/or chipset (such as a Bluetooth® device, a 802.6 device, a Wi-Fi device, a WiMAX device, cellular communication facilities, etc.), and/or the like. The communications subsystem 330 may permit data to be exchanged with a network (such as the network described below, to name one example) and/or any other devices described herein. In many embodiments, the computational system 300 will further include a working memory 335, which can include a RAM or ROM device, as described above.

The computational system 300 also can include software elements, shown as being currently located within the working memory 335, including an operating system 330 and/or other code, such as one or more application programs 345, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 325 described above.

In some cases, the storage medium might be incorporated within the computational system 300 or in communication with the computational system 300. In other embodiments, the storage medium might be separate from the computational system 300 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 300 and/or might take the form of source and/or installable code, which, upon compilation and/or installation on the computational system 300 (e.g., using any of a variety of generally available compilers, installation programs, compression/decompression utilities, etc.), then takes the form of executable code.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

1.-3. (canceled)

4. A method for multi model switching to tune AI models for a video feed, the method comprising:
obtaining an AI model for a camera;
obtaining data internal to the camera;
obtaining data external to the camera;
obtaining data related to objects of interest for the camera; and
modifying the AI model for the camera based on the data obtained.
